(19) United States
(12) Patent Application Publication
(10) Pub. No.: US 2020/0086526 A1
(43) Pub. Date: Mar. 19, 2020

(54) POURED MATERIAL FORMING SYSTEM

(71) Applicant: Architectural Polymers, Inc., Palmerton, PA (US)

(72) Inventor: Marshall Gilbert WALTERS, Lehighton, PA (US)

(21) Appl. No.: 16/561,331

(22) Filed: Sep. 5, 2019

Related U.S. Application Data
(60) Provisional application No. 62/732,804, filed on Sep. 18, 2018.

(51) Int. Cl. B28B 7/36; E04B 2/84

(52) U.S. Cl. CPC B28B 7/364; E04B 2/84

(57) ABSTRACT

A poured material forming system, including a thin polymer liner for receiving a poured material for forming a wall upon curing of the poured material, the liner containing a texture to be transferred onto the cured poured material. The poured material forming system including a support material positioned opposite the poured material during curing of the poured material for preventing deformation of the liner.

### FIELD OF THE INVENTION

This application is directed to the field of poured material forming systems, and in particular, to poured material forming systems using form liner panels.

### BACKGROUND OF THE INVENTION

Form liners or form liner panels are often used in the preparation of designs on tilt-up, cast-in-place, and precast walls constructed from formed materials such as concrete. A form liner is placed on the inside of a concrete forming system before the concrete has been poured and acts as a mold for the newly poured concrete. Once the concrete has set, the forming system and form liner can be stripped from the hardened concrete. The concrete is now permanently textured with the pattern of the form liner. Examples of these textures include brick, stone, fractured flutes, artwork, and contemporary 3-D designs. The end users of this product include the precast concrete industry, the tilt-up concrete industry, and the cast-in-place construction industry, i.e., bridge and highway projects.

One type of form liner is constructed from plastic materials, such as thermoformed styrene and acrylonitrile butadiene styrene (ABS). This form liner system is effective in economically transferring the desired texture to the finished concrete. However, a limitation of the plastic form liner is the ability to support the weight of the curing concrete on many textures. That is, as a result of areas of the form liner being vertically spaced relative to the ground or base surface, those areas would be susceptible to being smashed flat or at least partially vertically deflected or distorted under the weight of the concrete. When distortion of the form liner occurs, the visual appearance of the finished concrete texture is adversely affected. Because of this limitation, the range of patterns usable with the thermoformed sheet form liner system is significantly limited. Crude two-dimensional backing or support materials, such as small wood blocks or shims were sometimes hastily constructed at the job-site level and positioned under the lifted areas of the form liner in an attempt to support the weight of the curing concrete. Rarely did this backing material sufficiently match the profile of the desired texture, often resulting in distortion of the form liner. Furthermore, there was nothing available for more complex or custom 3-dimensional patterns.

There is a need in the art to address at least the following shortcomings:
1) support the weight of the curing concrete for all offered textures;
2) match the 3-dimension profile of the texture of the form liner with precision; and
3) provide pre-assembled backing system to the jobsite for ease of use.

### SUMMARY OF THE INVENTION

In an exemplary embodiment, a poured material forming system, including: a thin polymer liner for receiving a poured material for forming a wall upon curing of the poured material, the liner containing a texture to be transferred onto the cured poured material; and a support material positioned opposite the poured material during curing of the poured material for preventing deformation of the liner.

In another exemplary embodiment, a poured material forming system, comprising: a thin polymer liner for receiving a poured material for forming a wall upon curing of the poured material, at least a portion of the liner containing a texture to be transferred onto the cured poured material; and a support material positioned on a remaining portion of the liner and in contact with the poured material, the backing material having a texture to be transferred onto the poured material.

In a further exemplary embodiment, a method of forming a wall, includes providing a thin polymer liner and pouring a poured material for forming the wall received by the liner, the wall forming upon curing of the poured material, the liner containing a texture to be transferred onto the cured poured material. The method further includes positioning a support material opposite the poured material during curing of the poured material for preventing deformation of the liner.

Various features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a front perspective view of a structure utilizing an exemplary tilt-up concrete wall.

FIG. 2 is an upper perspective view of an exemplary backing material applied to a form liner.

FIG. 3 is an upper perspective view of an exemplary backing material applied to a form liner.

Wherever possible, the same reference numbers will be used throughout the drawings to represent the same parts.

### DETAILED DESCRIPTION OF THE INVENTION

Applicant has developed a fabricated backing system that can be machined to essentially match the exact 3-D profile of the plastic form liner or panel or sheet. In one embodiment, the fabrication of the backing system may be accomplished by using a computer numerical control (CNC) machine to mill the backing material to essentially the exact profile of the plastic form liner system. As a result of the prefabrication of the backing material, the installation process is streamlined, thus reducing time of installation and on-site labor costs by eliminating the need to manufacture backing pieces at the application site.

As a result of this novel backing system, the ability to use intelligent 3-D model-based processes, such as Building Information Modeling (BIM) to manufacture backing material, the use of plastic form liners can be expanded to include more complex texture designs, such as true 3-D graphics, contemporary geometric designs, and deeper relief textures. These types of concrete textures were only previously accomplished with the more expensive urethane form liner systems, and in most cases were:

1) not economically feasible to be used in the project, and/or

2) did not offer a simple procedural and dependable process to guaranty the desired architectural effect.

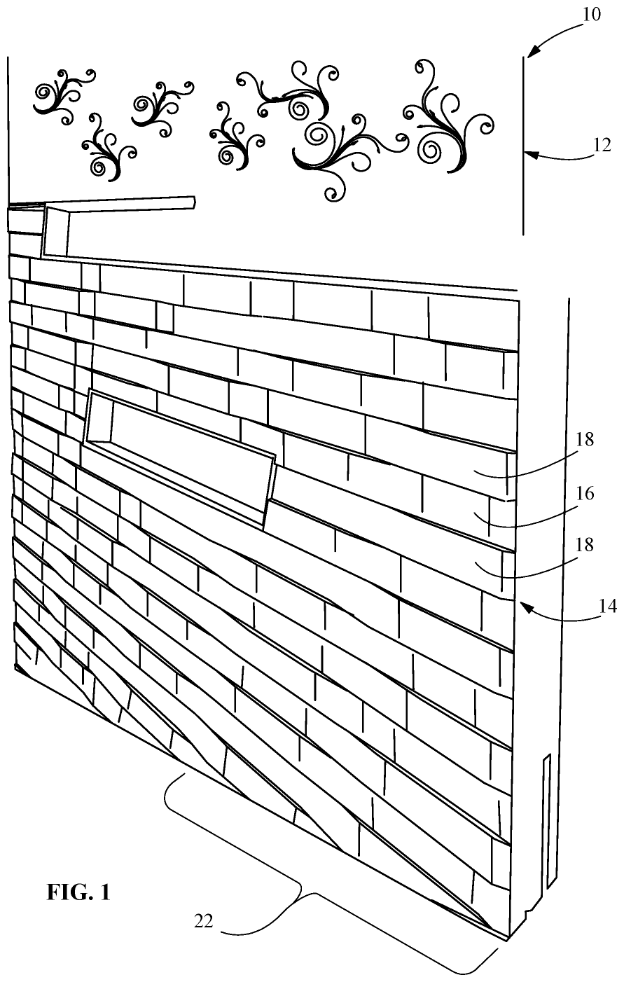

FIG. 1 shows an exemplary tilt-up wall composed of a poured material such as a concrete wall 10 having separate textures 12, 14 applied to different portions of concrete wall 10. Texture 14 includes, for example, raised portions 18 extending further outwardly from the surface of texture 14 relative to other adjacent portions 16, providing an aesthetically pleasing 3-D surface profile. Texture 12 is composed of a complex pattern of curved indented elements forming a different aesthetically pleasing 3-D surface profile in concrete wall 10.

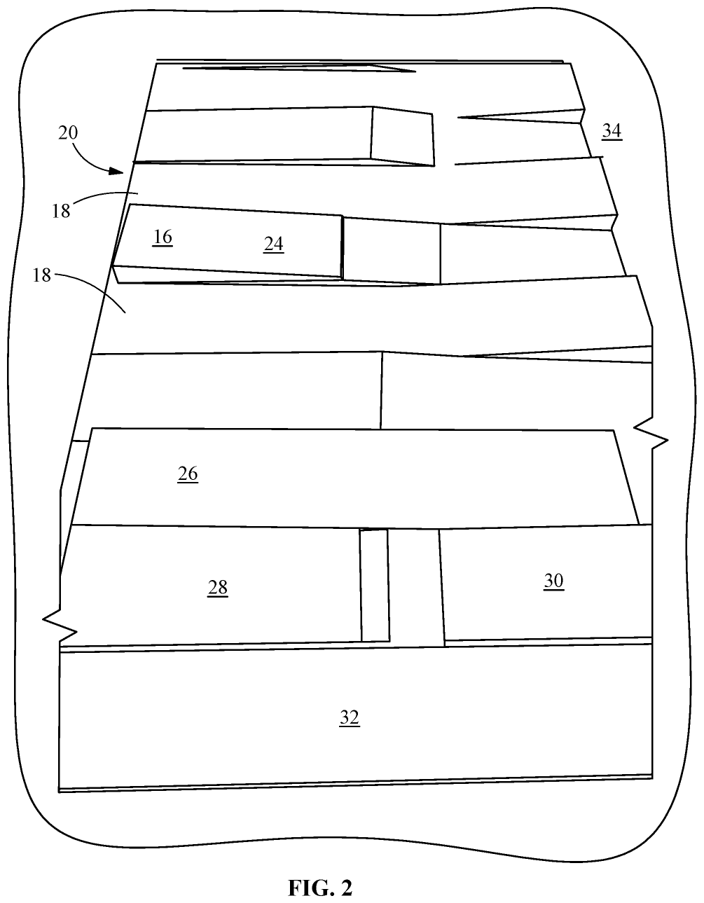

FIG. 2 shows an exemplary thin sheet or form or panel or liner 20 composed of a polymer such as a plastic. In one embodiment, the thickness of liner 20 is about 0.08 inch or less. Liner 20 corresponds to region 22 (FIG. 1) of texture 14 of wall 10 (FIG. 1). As shown in FIG. 2, support material 24, 26, 28, 30, 32 are positioned on liner 20. For purposes of comparison, portions 16, 18 of texture 14 of FIG. 1 of the wall are ultimately formed by poured material received on liner 20 and support material 24. That is, the recessed relief portion 16 of the wall, relative to raised portions 18 as shown in FIG. 1, is formed as a result of support material 24, which is positioned on a corresponding portion of liner 20 (FIG. 2) displacing poured concrete. In one embodiment, liner 20 is supported by a horizontal support surface 34 prior to positioning support material 24, 26, 28, 30, 32 and pouring the concrete.

Support material 24, as well as support material 26, 28, 30, 32, may be formed of closed cell foam, such as polyurethane or other suitable material having sufficient strength and rigidity and compatibility with the poured concrete so as to resist deforming while the concrete cures, including the ability to be easily separated from the poured concrete. The support material is fabricated at a manufacturing facility prior to transporting the poured material forming system to the application site. In one embodiment, the support material may be positioned on the liner 20 at the application site. In one embodiment, the support material may be affixed to the liner prior to transporting the liner to the application site.

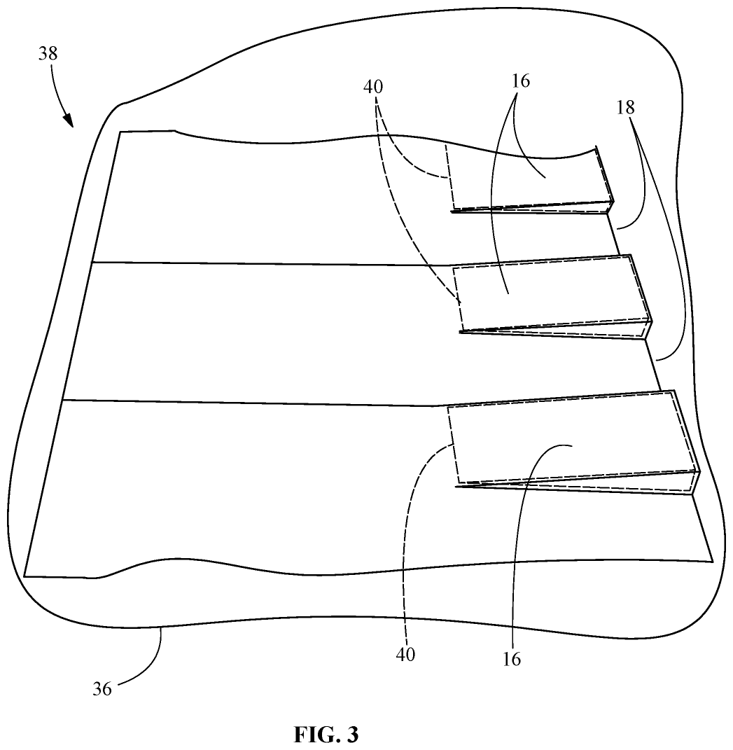

In an alternate embodiment as shown in FIG. 3, a horizontal support surface 36 supports a liner 38 having portions 16, 18 as previously discussed. However, in this embodiment, support material 40 is positioned beneath corresponding portions 16 of liner 38, providing support for liner 38 without being brought into contact with the poured concrete. That is, support material 40 is positioned between liner 38 and horizontal support surface 36. Since support material 40 does not contact the poured concrete, support material 40 does not have the requirement to be easily separated from the poured concrete, and therefore may permit additional materials to be used that otherwise may not be suitable for use with poured concrete.

It is to be understood by those having ordinary skill in the art that the poured material forming system may be utilized for portions of a wall that are not generally flat or planar, e.g., curved portions or edges, so long as a liner support surface is provided that can provide structural support for the liner while the poured material is curing.

In one embodiment, the liner may be formed by additive manufacturing techniques, such as 3-D printing. In one embodiment, the support material may be formed by additive manufacturing techniques, such as 3-D printing. In one embodiment, the support material may define a single, continuous geometry.

While the invention has been described with reference to a preferred embodiment, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A poured material forming system, comprising:
a thin polymer liner for receiving a poured material for forming a wall upon curing of the poured material, the liner containing a texture to be transferred onto the cured poured material; and
a support material positioned opposite the poured material during curing of the poured material for preventing deformation of the liner.

2. The poured material forming system of claim 1, wherein the liner has a thickness of 0.08 inch or less.

3. The poured material forming system of claim 1, wherein the liner is composed of a polymer.

4. The poured material forming system of claim 1, wherein the liner is composed of a closed cell foam.

5. The poured material forming system of claim 1, wherein the support material is affixed to the liner.

6. A poured material forming system, comprising:
a thin polymer liner for receiving a poured material for forming a wall upon curing of the poured material, at least a portion of the liner containing a texture to be transferred onto the cured poured material; and
a support material positioned on a remaining portion of the liner and in contact with the poured material, the backing material having a texture to be transferred onto the poured material.

7. The poured material forming system of claim 6, wherein the liner has a thickness of 0.08 inch or less.

8. The poured material forming system of claim 6, wherein the liner is composed of a polymer.

9. The poured material forming system of claim 6, wherein the liner is composed of a closed cell foam.

10. The poured material forming system of claim 6, wherein the support material is affixed to the liner.

11. A method of forming a wall, comprising:
providing a thin polymer liner;
pouring a poured material received by the liner for forming the wall, the wall forming upon curing of the poured material, the liner containing a texture to be transferred onto the cured poured material; and
positioning a support material opposite the poured material during curing of the poured material for preventing deformation of the liner.
